(19) United States
(12) Patent Application Publication
(10) Pub. No.: US 2022/0007894 A1
(43) Pub. Date: Jan. 13, 2022

(54) FOOD PREPARATION APPARATUS FOR CUTTING FOODS

(71) Applicant: Vorwerk & Co. Interholding GmbH, Wuppertal (DE)

(72) Inventors: Felix Thies, Wuppertal (DE); Kai Landsecker, Düsseldorf (DE); Phillipp Tepel, Wuppertal (DE)

(21) Appl. No.: 17/370,556

(22) Filed: Jul. 8, 2021

(30) Foreign Application Priority Data
Jul. 9, 2020 (EP) 20184886.8

(51) Int. Cl. A47J 44/00; A47J 43/08; A47J 43/25; A47J 43/07

(52) U.S. Cl. CPC A47J 44/00; A47J 43/0722; A47J 43/255; A47J 43/085

(57) ABSTRACT

The present disclosure relates to a food preparation apparatus with a rotatable chopping tool for chopping foods having a control unit. The chopping tool is arranged or arrangeable relative to a vessel in such a way that foods chopped by means of the chopping tool are transported downwards by gravity to be collected in the vessel. Furthermore, the disclosure relates to a method for chopping a food using a food preparation apparatus, a computer program product, and a use of a chopping attachment. A food preparation apparatus comprises a control unit configured to set a target parameter of a chopping process of a food by means of the chopping tool taking into account provided information. In this way, a particularly good and reproducible chopping result is achieved.

### CROSS REFERENCE TO RELATED APPLICATIONS

This application claims priority to and the benefit of European Patent Application Number 20184886.8, filed 9 Jul. 2020, the disclosure of which is now expressly incorporated herein by reference.

### TECHNICAL FIELD

The present disclosure relates to a food preparation apparatus with a rotatable chopping tool for chopping foods having a control unit. The chopping tool is arranged or arrangeable relative to a vessel in such a way that foods chopped by means of the chopping tool are transported downwards by gravity to be collected in the vessel. Furthermore, the disclosure relates to a method for chopping a food using a food preparation apparatus, a computer program product, and a use of a chopping attachment.

### BACKGROUND

Food preparation apparatuses that are used to chop food are known. For example, food preparation apparatuses are available that allow several different food preparation processes such as chopping, mixing and heating, also known as all-in-one food processors. Add-on devices for food processors are also known that allow foods to be cut. In both cases, the devices have a rotational speed that cannot be adjusted or can only be adjusted in coarse increments. The processing of the foods or the setting of the respective processing process usually takes place independently of the food to be cut. In addition, kitchen robots are known, i.e. digitally supported food preparation apparatuses that are able to guide the user through digital recipes. These also allow chopping of foods.

Sometimes, the chopping of food is carried out depending on the user's experience with the device used. The setting of the relevant chopping parameters such as cutting speed, feed force, etc. is either not adjustable or only adjustable based on user experience or manufacturer specifications. The result suffers from this if, for example, soft foods such as bananas are chopped with the same parameters as hard or tough foods such as sweet potatoes. Incorrect settings by the user are also possible, affecting the result. Soft foods are often fed into the chopping tool with an excessive feed force, for example, which destroys them.

The aforementioned features known from the prior art may be combined individually or in any combination with any of the objects and configurations of the embodiments described in the following description.

### SUMMARY

It is the object of the present disclosure to provide a further developed food preparation apparatus, a method, a computer program product and a use.

A food preparation apparatus having a rotatable chopping tool for chopping foods serves to solve the task. The chopping tool is arranged or arrangeable relative to a vessel in such a way that, after chopping by means of the chopping tool, a food falls down due to gravity in order to be collected in the vessel. The food preparation apparatus comprises a control unit configured to set a target parameter of a chopping process of a food by means of the chopping tool, taking into account provided information.

By setting the target parameter, the control unit makes it possible to specify relevant information for the current chopping process. This information can be used to adapt each chopping process individually to the specific conditions. In this way, a particularly good and reproducible chopping result is achieved. Concrete properties of the food to be chopped, also referred to as food to be cut, are taken into account. For example, soft foods can be chopped with a lower feed force than hard foods. The dependence of the chopping result on external influences or error sources, such as user behavior and the nature of the food to be cut, is minimized. User-friendliness is further increased.

A food preparation apparatus is an apparatus with which at least one step of a food preparation can be performed, such as mixing, chopping or heating. A food can be solid or liquid. Also a single ingredient or a quantity of an ingredient, for example one potato or 500 g of carrots, is a food in the sense of the present disclosure.

In particular, the chopping tool is arranged or arrangeable with respect to the vessel such that foods are chopped by the chopping tool as they enter the vessel. The food preparation apparatus may comprise the vessel. After chopping, a food falls down by gravity to be collected in the vessel. Thus, the food passes through the chopping tool to be subsequently collected below it. The food passes the chopping tool only once, so that a particularly defined chopping process is possible. A food processor with a chopping tool that is rotatable in a food preparation vessel and is located near the bottom of the food preparation vessel is not a chopping tool according to the claims. By rotating such a chopping tool, food can also be conveyed and chopped in the opposite direction to gravity. Such a chopping tool is therefore designed and suitable for food to pass the chopping tool several times in order to be chopped.

In the following, exemplary embodiments of the present disclosure are explained in more detail with reference to figures. Features of the embodiment examples can be combined individually or in a plurality with the claimed subject-matter, unless otherwise indicated. The claimed scopes of protection are not limited to the embodiments.

### BRIEF DESCRIPTION OF THE DRAWINGS

The figures show:

FIG. 1: a schematic exploded view of a chopping attachment;

FIG. 2: a flowchart of a user guide of the food preparation apparatus;

FIG. 3: a flow chart of method steps;

FIG. 4: a first characteristic curve;

FIG. 5: a second characteristic curve;

FIG. 6: a schematic representation of a food preparation apparatus

### DETAILED DESCRIPTION

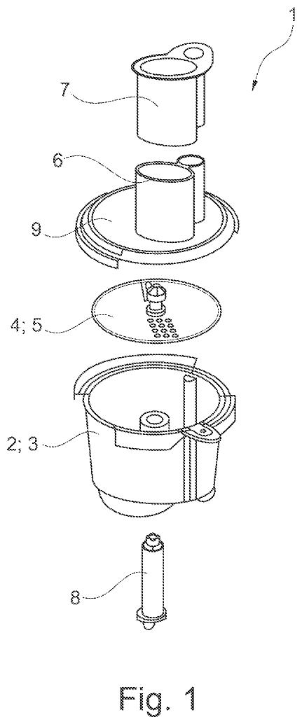

FIG. 1 shows a schematic representation of a chopping attachment as part of a food preparation apparatus 1. In the lower region, an adapter 8 is shown which serves for the rotationally fixed connection of the chopping tool 4, configured here as a cutting disc 5, with the drive shaft or with at least a part of the mixing tool. In this way, the electric motor of the food preparation apparatus (not shown here), which drives the drive shaft and thus the mixing tool of the food preparation apparatus, can also be used to rotationally drive the chopping tool of the chopping attachment.

The adapter 8 is designed as a shaft and runs through a vertical cavity inside the vessel 2. It passes through the vessel 2 at the upper side of the cavity, where it can be connected to the cutting disk 5. The vessel 2 has a W-shaped cross-section and serves for collecting cut food. It is configured as an attachment for arrangement in a food preparation vessel of the food preparation apparatus 1. The upper region of the vessel 2 serves as housing part 3 for enclosing the cutting disc 5. A cover 9 covers the vessel 2 and encloses the cutting disk towards the environment. In the cover 9 there are two openings 6 of different sizes arranged next to each other, which are configured as filling necks for inserting foods to be chopped. Associated and appropriately dimensioned plungers 7 interconnected with each other serve for pushing the food downwards onto the cutting disc 5.

The food preparation apparatus further comprises a control unit (not shown), which is configured to set a target parameter of a chopping process, namely a target feed force, taking into account provided information about the food to be chopped, for example a database content or a measured value of the rotational speed as well as the motor current for determining the power consumption for the purpose of calculating the torque on the basis of food properties. The control device can determine the actual feed force using a sensor signal of a compressive force sensor (also not shown) inside the standing feet of the food preparation apparatus. For this purpose, it can use measured and known compressive force values and determine the actual compressive force exerted by the user by difference formation and, if necessary, conversion. It may take into account the mass of the vessel and/or of the food preparation vessel, of the food contained therein, and of other parts of the food preparation apparatus, if necessary. The mass of the food may be known, for example, based on the stored recipe or weighing history. The currently applied compressive force can be compared to the target parameter. Further, the food preparation apparatus comprises an output device by means of which it can output output information relating to the target parameter to the user, namely the information: “pressure too high”, “pressure just right” or “pressure too low”. The user can perceive the output and adjust his or her pressure on the food accordingly. This can be repeated in very short time intervals such that the user is provided with real-time feedback on the compressive force exerted.

The target parameter can be output to the user by an output unit. Likewise, if the actual value of the corresponding parameter deviates from the target value, a hint can be output. This occurs, for example, if one of the values is outside a predetermined tolerance range of the other value, i.e. if the deviation is too large. Also, a hint to change the operating parameter can be output to the user, or a suggestion with a currently more suitable value of the respective parameter. This can be done to improve the chopping result and/or to protect the food preparation apparatus from excessive load. For this purpose, the control unit may take into account a content of a connected database. The food preparation apparatus may further be configured to influence the rotation of the chopping tool in order to control the chopping process taking into account the information. In this case, the rotational speed is automatically adjusted to bring the actual value in line with the target value. User interaction is not necessary in this case.

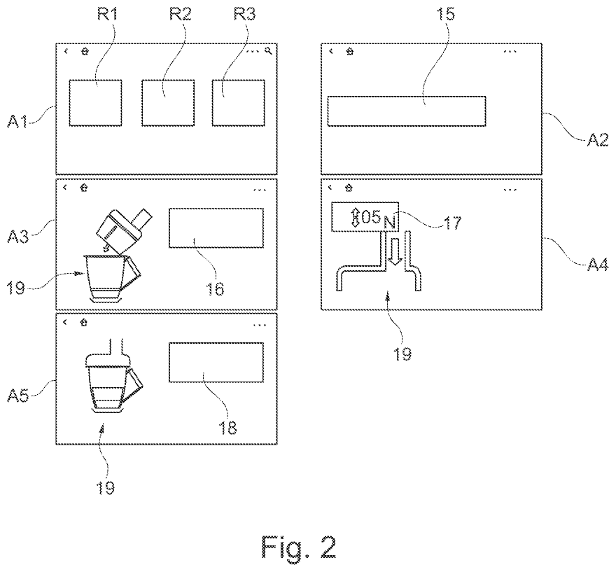

FIG. 2 shows a flow diagram of a user guidance of the food preparation apparatus 1 output on the output device by the control unit. The control unit is configured to output guidance information 16, 18 to a user via the output device, which serves for guiding the user through individual preparation and/or work steps of a food preparation process.

In a first output A1, the user has a choice of several electronic recipes R1, R2, R3 stored in a database. After selection of a first recipe R1, the hint 15 appears in the second output A2 that the chopping attachment for the food preparation apparatus 1 is required. In the third output A3, the user is shown as a first guidance information 16 that the chopping attachment is to be manually attached to or on the food preparation vessel. Next to this, a pictogram 19 is shown which visually depicts this. In the underlying apparatus here, the housing part for housing the chopping tool of the chopping attachment is merely designed in a jacket-like shape and does not have an own bottom for collecting the foods, so that chopped foods directly fall into the food preparation vessel of the food preparation apparatus for further processing there. The fourth output A4 shows an output information 17 relating to the target parameter, which is output by the control unit taking into account at least one current compressive force measurement value. Here, a target compressive force in Newton is first indicated as the target parameter. Subsequently, arrows indicate a compressive force exerted by the user that is too high or too low. In addition, a pictogram 19 schematically shows the position whose compressive force is represented in the output information 17. The fifth output A5 shows a second guidance information 18, namely the hint that 200 g of potatoes are to be added.

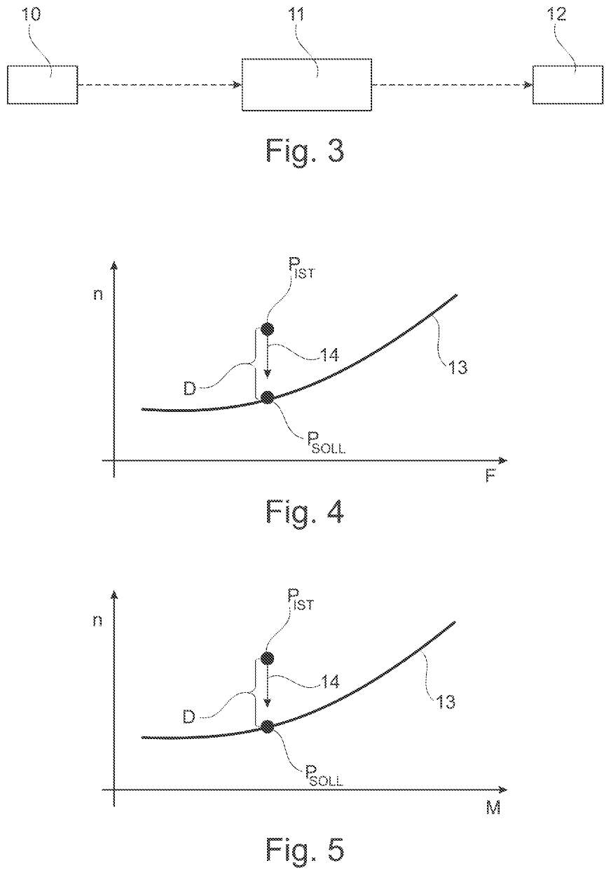

FIG. 3 shows a setting of the target parameter 12 executed by the control unit. An input 10, namely an input relating to a food to be chopped, is provided to the control unit. This may be specified by the recipe or entered manually by the user. A comparison 11 with a database is made. Individual foods and assigned target parameters are specified therein. The control unit searches for the size of the appropriate target parameter 12 and sets it.

FIG. 4 shows a first characteristic curve 13, FIG. 5 shows a second characteristic curve 13. In the configuration of FIG. 4, the characteristic curve 13 shown in a compressive force/rotational speed diagram defines a relationship between the compressive force F and the rotational speed n of the chopping tool, which is a measure of the cutting speed. The compressive force F or feed force typically means the force with which a food to be chopped is pressed against the chopping tool along the feed direction. It may be proportional to the feed speed of the food to be chopped and may be detected by means of a weight sensor, for example. The rotational speed n is characterized by the rotational speed of the motor.

In another configuration shown in FIG. 5, the characteristic curve 13 defines a relationship between the rotational speed n and the cutting torque M. The cutting torque M refers to the torque of the chopping tool in relation to the food to be chopped. The cutting torque M is proportional to the motor torque and can be measured, for example, by means of a motor current sensor.

In both of the above-mentioned configurations, a current operating state is determined by the control unit during the chopping process by measuring the rotational speed of the motor as well as the compressive force (e.g., via the weight force sensor) or the cutting torque (e.g., via the motor current). Thus, a current operating point P_{IST} is determined, which is compared with the characteristic curve 13.

The target operating point P_{SOLL} lies on the characteristic curve 13. A difference D is determined from the target rotational speed according to the respective characteristic curve 13 and the measured rotational speed n. The control unit performs an influence 14 of the rotation of the chopping tool on the basis of the target parameter in order to regulate the chopping process taking the information into account. For this purpose, the rotational speed n is changed to the target rotational speed so that the characteristic curve 13 is reached when the compressive force F or the cutting torque M remains constant. The food preparation apparatus thus adapts the rotational speed to the compressive force currently exerted by the user. Interaction by the user is therefore not required and the chopping process is performed in the optimum range.

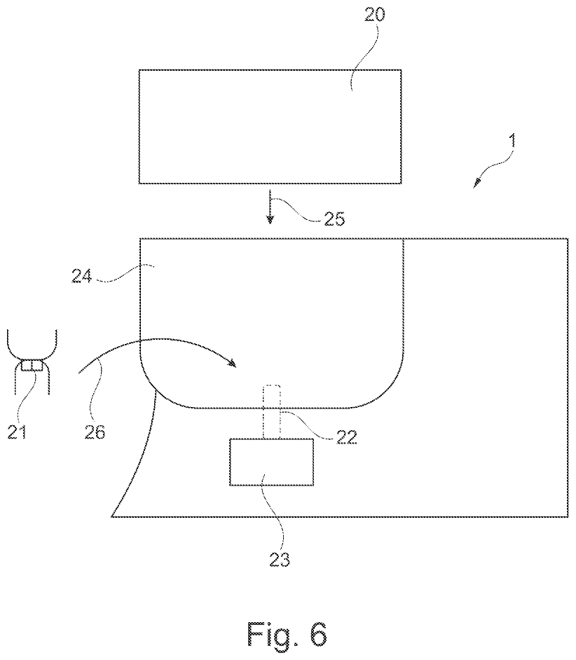

FIG. 6 schematically shows a food preparation apparatus 1. This comprises an electric motor 23, a drive shaft 22 driven by the latter, and a food preparation vessel 24. On the drive shaft 22 which is exposed in the food preparation vessel 24, the mixing tool 21 for chopping and mixing foods in the food preparation vessel 24 can be attached, as indicated by the arrow 26. The chopping attachment 20 can be manually placed and fixed on the food preparation vessel 24, as indicated by the arrow 25. The chopping attachment 20, shown here only as an outline, comprises a rotatable chopping tool for chopping food. In particular, as shown in FIG. 1, it comprises an adapter by means of which it can be connected to the mixing tool 21 or to the drive shaft 22 in a rotationally fixed manner. The vessel can be firmly connected to the food preparation vessel by the manual attachment. The axis of rotation of the chopping tool corresponds to the axis of rotation of the drive shaft 22 as well as of the mixing tool 21. The electric motor 23 can thus drive the chopping tool of the chopping attachment 20. The chopping attachment 20 further comprises a vessel, wherein the chopping tool is arranged relative to the vessel such that a food, after being chopped by means of the chopping tool, falls downwards due to gravity to be collected in the vessel, as shown in FIG. 1.

In particular, the chopping tool is arranged or arrangeable with respect to the vessel such that foods are chopped by the chopping tool as they enter the vessel. The food preparation apparatus may comprise the vessel. After chopping, a food falls down by gravity to be collected in the vessel. Thus, the food passes through the chopping tool to be subsequently collected below it. The food passes the chopping tool only once, so that a particularly defined chopping process is possible. A food processor with a chopping tool that is rotatable in a food preparation vessel and is located near the bottom of the food preparation vessel is not a chopping tool according to the claims. By rotating such a chopping tool, food can also be conveyed and chopped in the opposite direction to gravity. Such a chopping tool is therefore designed and suitable for food to pass the chopping tool several times in order to be chopped.

In particular, the chopping tool has a distance of at least 10 cm, in particular at least 15 cm, from a bottom of the vessel. The distance is measured between the lowest point of the bottom and the lowest point of the chopping tool. Chopped foods thus fall down at least 10 cm.

The food preparation apparatus may comprise a food preparation vessel. This may be configured to perform a food preparation operation in which a food may be processed, for example, by means of an element for mixing and/or chopping, and/or may be heated by means of a heating element. The vessel may be configured as an attachment for arrangement in said food preparation vessel. This means that it can be positioned from above in or on the food preparation vessel and, if necessary, locked in place. This is usually done manually. In other words, the vessel is releasable and usually manually. In particular, the vessel is reversibly attachable to and/or on the food preparation vessel. The vessel may be an attachment in the form of a cover for the food preparation vessel. In this embodiment, chopped food can be collected in the vessel, which is arranged in or above the food preparation vessel. The vessel may have a centrally and/or vertically extending opening through which a drive shaft of the food preparation apparatus may pass to drive the chopping tool. The food preparation apparatus can be configured such that, in the described positioned state of the vessel, a drive shaft runs through the food preparation vessel in order to drive the chopping tool by means of a motor located below the food preparation vessel.

The vessel can alternatively be the food preparation vessel of the food preparation apparatus itself. Also in this case, the chopping tool is arranged above a bottom for collecting the chopped foods, so that the latter fall down by gravity and can be collected there. Typically, the chopping tool is arranged in a housing part which is designed in the shape of a jacket or has a substantially circular cross-section, so that chopped foods pass through the housing part by gravity directly into the food preparation vessel and are collected there. This housing part can be configured as an attachment for arrangement in the food preparation vessel, as described above. In this respect, reference is made to the above explanations. In this case, direct further processing of the food is possible.

In particular, the chopping tool has at least one cutting edge for chopping, for example by cutting and/or grating. The chopping tool may be a cutting disc or a grating disc. It may have elongated, substantially radially arranged blades for cutting slices, for example of potatoes. It may alternatively or additionally have locally defined recesses or troughs provided with a blade, for example for grating vegetables. The function may be dependent on the direction of rotation of the disc. The chopping tool can be part of a chopping attachment.

The provided information is information provided or available to the control unit. In particular, information relating to the current chopping process is meant. The information can be, for example, an input of a user, a sensor signal of a sensor, information present in an internal or connected database, or information derived from one or more of these. Determining taking into account the provided information allows in principle that further information can be taken into account in the process. In particular, the control unit can set the target parameter during the chopping process.

A target parameter means a target value of a parameter. A target parameter of a chopping process means in particular a target value of a parameter that is optimal for a current chopping process. This is provided for controlling and/or regulating the chopping process. If the chopping process is regulated by the target parameter, thereby, for example a cutting speed of the chopping tool can be set. A cutting speed thus then depends on the provided information. Alternatively or additionally, a cutting force can depend on the information provided. If, based on the provided information, a cutting force is not to exceed a predetermined value, then the electrical power supplied for operating the chopping tool is regulated such that the predetermined value is not exceeded.

To set means to determine or define, for example, by calculating, searching from a database, assigning to the provided information, etc. The target parameter can be, for example, a certain rotational speed of the chopping tool. The control unit can assign this rotational speed, for example, to the information provided to it that a certain food to be chopped is present.

In one embodiment, the food preparation apparatus further comprises at least one of the following features: a food preparation vessel, a heating element for heating a food in the food preparation vessel, a mixing tool for mixing and/or chopping a food in a bottom region of the food preparation vessel, a drive shaft for rotating the mixing tool, an electric motor for driving the drive shaft. The control unit may be configured to control a heating operation of a food by means of the heating element. In operation, a food may be placed in the food preparation vessel and the food may be prepared in the food preparation vessel. Preparing a food means processing by mixing, chopping, and/or heating.

In particular, the food preparation vessel is not identical to the vessel. Also foods present in the food preparation vessel can be chopped by the mixing knife. After chopping, however, these do not fall down to be collected in the vessel, but remain in the food preparation vessel.

In one embodiment, the target parameter is a target cutting speed, a target cutting force, a target feed speed, and/or a target feed force.

The cutting force refers to the force or torque with which the chopping tool is moved in relation to the food to be chopped or in relation to the vessel. The cutting speed refers to the speed at which the chopping tool is moved in relation to the food to be chopped or in relation to the vessel. Since the cutting force and the rotational speed of the chopping tool and/or the motor can be converted into each other, only the cutting force is discussed here. All explanations apply accordingly to the rotational speed of the chopping tool and/or motor. Since the cutting torque and the cutting force can be converted into each other, only the cutting force is discussed here. All explanations apply accordingly to the cutting torque.

The feed speed and the feed force relate to feeding the food to be chopped to the chopping tool, in particular to inserting the food to be chopped through an opening in a cover of the food preparation apparatus. The feed force and feed speed act along the feed direction, i.e. the direction with which the food to be chopped is moved. The feed direction is preferably aligned parallel to the axis of rotation of the chopping tool.

In one embodiment, the control unit is connected or connectable to a database and configured to take into account a content of the database in addition to the provided information for setting the target parameter. For example, in a simple case, the database comprises different foods and, assigned to each of them, a suitable rotational speed for the chopping tool for chopping the food. Based on the provided information regarding the type of food to be chopped and the database, the control unit can now set a target parameter such as a target rotational speed. Basically, the chopping tool is then rotated at this target rotational speed during operation. However, the rotational speed of the chopping tool can be lower, for example, if an excessively high resistance occurs. The database may be an internal database stored in a memory unit of the food preparation apparatus and/or the control unit. Alternatively, the database may be an external database that can be accessed by the control unit via a data network such as the Internet. This embodiment enables an even better and reproducible chopping result.

In a further embodiment, the food preparation apparatus comprises at least one sensor. The control unit is configured to set the target parameter taking into account a sensor signal of the sensor. The sensor provides a sensor signal to the control unit. This serves in particular as information that is provided. The sensor may serve to detect a sensor signal relating to a property of the food and/or a part of the food preparation apparatus. A sensor signal may be a signal, in particular an analog signal, whose voltage, current and/or frequency correlates with the measured quantity. For example, the control unit can set a target rotational speed based on a sensor signal of a force sensor. This embodiment enables a particularly reproducible chopping result through the detection of a sensor signal, taking measured properties into account.

In one further embodiment, a sensor is provided for detecting a compressive force exerted on a part of the food preparation apparatus and/or a weight of a chopped food. In particular, the food preparation apparatus comprises the sensor. The sensor may be configured as a force sensor for detecting a weight force. The sensor may be configured to detect the sum of the weight force of the entire food preparation vessel or parts of the food preparation apparatus and the chopped food. The weight of the chopped food refers to the chopped food arranged in the vessel. A sensor for detecting a compressive force means a sensor suitable for detecting information relating to a compressive force. This applies accordingly to all other sensors. In one embodiment, a sensor is arranged in at least one standing foot and in particular in each standing foot of the food preparation apparatus.

The control unit can be configured to determine the weight of the chopped food and/or the exerted compressive force by forming a difference by subtracting the known masses of the relevant parts of the food preparation apparatus. The compressive force is generated in particular by manually pressing a food to be chopped onto the chopping tool, typically the cutting disc. The compressive force can be proportional to the feed speed.

In one embodiment, the control unit is configured to determine a filling level in the vessel based on the sensor signal. For this purpose, the control unit takes into account, in particular, information relating to the density of the chopped food. This can be, for example, the provided information or be based on it. The food preparation apparatus may be configured to output the filling level by means of an output device. The control unit may be configured to determine a filling level in the food preparation vessel based on the sensor signal. The filling level may relate to solid or liquid foods or mixtures thereof.

Filling level indicators in the form of windows are known. In the case of insertion devices, such indicators are often not possible due to the opaque walls of the outer vessel, in this case the food preparation vessel. This embodiment of the disclosure brings the advantage that the filling level detection further increases user-friendliness.

In one configuration, a sensor is provided for detecting a motor torque of a motor for driving the chopping tool. A sensor in this context is a device suitable for detecting information relating to a motor torque. The sensor may be configured to detect a motor current of the motor for the purpose of detecting the motor torque. The sensor signal of this sensor may serve as information. The food preparation apparatus may comprise the sensor and/or the motor.

In one embodiment, the food preparation apparatus is configured to influence a rotation of the chopping tool on the basis of the target parameter. Through this, the chopping process can be controlled taking into account the information. In particular, the control unit is configured to influence the rotation. This embodiment can be referred to as direct control, since the food preparation apparatus directly or automatically performs the control of the chopping process. Influencing the rotation means, for example, changing the rotational speed and/or the torque or setting a certain rotational speed and/or a certain torque.

In a control process, for example, the rotation of the chopping tool is specifically influenced by the target parameter. The target parameter is set depending on a received and/or measured input variable, the provided information. This enables a quick and easy control of the chopping process and thus an improved user friendliness.

In one embodiment, the control unit is configured to regulate the rotation of the chopping tool on the basis of the target parameter as well as a detected status information relating to an actual status. The control unit serves for determining the target parameter as well as for influencing the rotation of the chopping tool. The regulation of the rotation of the chopping tool means the regulation of at least one parameter of the rotation such as the rotational speed or the torque.

During a regulation process (closed-loop control), a regulation variable is to be kept at a target value despite the effect of a disturbance variable. The target value is specified by the target parameter. Disturbance variables can be any environmental influences, such as the compressive force exerted on the food to be chopped or the nature of the food to be chopped. In principle, an actual value of the regulation variable is determined preferably continuously during a regulation process. In particular, the regulation variable is a status variable describing a current status, for example a rotational speed or a torque of the chopping tool. The actual value of the regulation variable describes the current status and is represented by the detected status information, such as a sensor signal. The actual status means the current status of the food preparation apparatus, especially during a chopping process. This embodiment causes an automatic and precise adjustment of the chopping process and thus a particularly defined chopping result and a further improved user friendliness.

In a further embodiment, the control unit is configured to access a characteristic curve and to take the characteristic curve into account in addition to the provided information for setting the target parameter. The characteristic curve defines a relationship between two physical variables during operation. For example, it defines a relationship between the rotational speed of the chopping tool and the compressive force or the cutting torque. If a provided information is available, the target parameter can be determined by means of the characteristic curve. The provided information may refer to an actual status. It can be a sensor signal such as e.g. a current rotational speed of the motor during a chopping process.

For regulating the rotation of the chopping tool, the control unit may be configured to determine a data point based on the provided information and a detected status information relating to an actual status and to compare it with the characteristic curve. If the point is on the characteristic curve or within a tolerance range around the characteristic curve, the actual parameter corresponds to the target parameter. Now an output to the user can take place. It is not necessary to influence the rotation by the food preparation apparatus, since the rotational speed is already optimally set. If the point is outside the characteristic curve or outside the tolerance range, the actual parameter deviates from the target parameter. In this case, a corresponding output to the user can take place or the rotation can be influenced by the food preparation apparatus.

The characteristic curve may be an internal characteristic curve that is stored in a memory unit of the food preparation apparatus and/or the control unit. Alternatively, the characteristic curve may be an external characteristic curve which can be accessed by the control unit via a data network such as the Internet.

Different characteristic curves can be available for different foods. Each food can therefore be assigned an own characteristic curve.

In one embodiment, the control unit is configured to output output information relating to the target parameter to a user via an output device. This can serve an indirect control, in which the target parameter is set by the control unit and a corresponding output information is output, but the actual setting or influencing is performed by the user. For example, the target parameter itself can be output and serve as a basis for influencing the manually applied compressive force on a food to be chopped by the user. The user can thus adjust a behavior, for example the applied compressive force when feeding a food to be chopped, in response to the output.

An output information may be, for example, the target parameter itself, a value derived from it such as a compressive force suitable for the determined value of the target parameter, or an output information based on the target parameter or a derived value such as a warning or a suggestion for a more suitable size of the parameter. This embodiment makes it possible to quickly and easily influence also parameters that are not adjustable by the device itself, in order to enable a reproducible and satisfactory chopping process.

In one configuration of the food preparation apparatus, the control unit is configured to consider a detected status information of an actual status for determining the output information relating to the target parameter. The determination of the output information means the determination of the information to be output. The detected status information of the actual status can be, for example, a current sensor signal of a sensor of the food preparation apparatus. In this way, for example, a current deviation from the target parameter can be output. The reproducibility of the chopping and the user-friendliness are thus further increased.

In one embodiment, the control unit is configured to receive an input from a user via an input device as information and to set the target parameter on the basis of the received input. The input device may be arranged on the food preparation apparatus or may be an external input device. The input of the user can be, for example, an input of an information relating to a food to be chopped or an input relating to a recipe step of a recipe to which the control unit has access.

In particular, the food preparation apparatus comprises an input device and/or an output device. These can be designed together as an input and output device, for example as a touchscreen.

In a further embodiment, the control unit is configured to output guidance information to a user via an output device. The guidance information serves for guiding the user through individual preparation and/or work steps of a food preparation process. The control unit may further be configured to receive input or commands of the user via an input device, for example a confirmation that a certain amount of an ingredient has been added, and to design the guidance through the food preparation process accordingly.

In a further embodiment, the chopping tool is rotatably arranged in a housing part, the food preparation apparatus comprises a cover for covering the housing part with an opening for inserting food to be chopped, and/or the chopping tool is arranged or arrangeable such that foods inserted through the opening are collected in the vessel after passing the chopping tool.

Passing the chopping tool means in particular the chopping by the chopping tool when the chopping tool is rotating. In particular, the chopping tool is arranged or arrangeable in a chopping tool plane and passing the chopping tool means passing, by the food, the chopping tool plane. In particular, the opening has the shape of a filling neck. It may be closeable by a plunger configured to push the food into it. The chopping tool may be a cutting disc, for example.

The chopping tool is rotatable in the housing part. The housing part serves to enclose the chopping tool. In particular, the food preparation apparatus comprises the housing part. The chopping tool is arranged or arrangeable within the housing part. The housing part need not be completely enclosed. The housing part may be part of the vessel, for example the upper rim thereof.

Another aspect of the disclosure is a method for chopping a food using a food preparation apparatus having a rotatable chopping tool for chopping foods. The chopping tool is arranged or arrangeable relative to a vessel in such a way that, after chopping by means of the chopping tool, a food falls downwards due to gravity to be collected in the vessel. A target parameter of a chopping process of a food by means of the chopping tool is set using a control unit taking into account information provided.

In particular, the method is carried out using the food preparation apparatus according to the present disclosure. The features, configurations and effects of the apparatus described at the beginning for solving the task accordingly also relate to this method. In particular, the method further comprises outputting an output information relating to the target parameter to a user by means of an output device and/or influencing a rotation of the chopping tool based on the target parameter by the control unit. The method may comprise regulating the rotation of the chopping tool based on the target parameter by the control unit. In one configuration, the control unit accesses a characteristic curve and considers the characteristic curve to determine the target parameter.

Another aspect of the present disclosure is a computer program product. This comprises instructions which, when the program is executed by a computer, cause the computer to carry out the steps of the method according to the preceding claim. In particular, the computer is a control unit of a food preparation apparatus. The features, configurations and effects of the apparatus described at the beginning as well as of the method for solving the task accordingly also relate to this computer program product.

Another aspect of the disclosed designs is a food preparation apparatus comprising a chopping tool rotatable in a housing part for chopping food, a control device, and a sensor for detecting a compressive force exerted on a part of the food preparation apparatus and/or a weight of a chopped food. The control device is configured to determine a filling level in a vessel or a food preparation vessel based on the sensor signal. The control device may be a control unit according to further aspects of the present disclosure. The features, configurations and effects of the apparatus described at the beginning for solving the task accordingly also relate to this aspect.

Another aspect of the present disclosure is a food preparation apparatus comprising a food preparation vessel, a heating element for heating a food in the food preparation vessel, a mixing tool for mixing and/or chopping a food in a bottom region of the food preparation vessel, a drive shaft for rotating the mixing tool, and an electric motor for driving the drive shaft. The food preparation apparatus further comprises a chopping attachment having a rotatable chopping tool for chopping foods. The chopping attachment can be attached to or on the food preparation vessel in a manually detachable manner. Preferably, the food preparation apparatus comprises an adapter configured to connect the chopping tool to the drive shaft or at least a portion of the mixing tool in a rotationally fixed manner such that the electric motor drives the chopping tool of the chopping attachment for rotation.

In particular, the chopping attachment is configured such that the chopping tool is arranged or arrangeable relative to a vessel in such a way that, after chopping by means of the chopping tool, a food falls downwards due to gravity to be collected in the vessel. The features, configurations and effects of the apparatus described at the beginning for solving the task accordingly also relate to this aspect.

Another aspect is the use of a chopping attachment for attachment to or on a food preparation vessel of a food preparation apparatus in a manually detachable manner. The chopping attachment comprises a rotatable chopping tool for chopping food. The chopping tool is arranged or arrangeable relative to a vessel in such a way that, after chopping by means of the chopping tool, a food falls downwards due to gravity to be collected in the vessel. The food preparation apparatus comprises at least one of the following: the food preparation vessel, a heating element for heating a food in the food preparation vessel, a mixing tool for mixing and/or chopping a food in a bottom region of the food preparation vessel, a drive shaft for rotating the mixing tool, an electric motor for driving the drive shaft. In particular, the manually detachable attachment is a manual reversible connection, wherein the connection can be manually detached. The vessel may be the food preparation vessel or a separate vessel.

Thus, the present disclosure also relates to use of a chopping attachment for attachment to or on a food preparation vessel of a food preparation apparatus in a manually detachable manner, wherein the chopping attachment comprises a rotatable chopping tool for chopping foods, the chopping tool being arranged or arrangeable relative to a vessel in such a way that after chopping by means of the chopping tool, a food falls downwards by gravity to be collected in the vessel, wherein the food preparation apparatus comprises a heating element for heating a food in the food preparation vessel, a mixing tool for mixing and/or chopping a food in a bottom region of the food preparation vessel, a drive shaft for rotating the mixing tool, and an electric motor for driving the drive shaft.

### LIST OF REFERENCE SIGNS

food preparation apparatus 1

vessel 2

housing part 3

chopping tool 4

cutting disc 5

opening 6

plunger 7

adapter 8

cover 9

input 10

comparison 11

target parameter 12

characteristic curve 13

influence 14

hint 15

first guidance information 16

output information 17

second guidance information 18

pictogram 19

chopping attachment 20

mixing tool 21

drive shaft 22

electric motor 23

food preparation vessel 24

arrow 25

arrow 26

rotational speed n

compressive force F

cutting torque M

current operating point P_{IST}

target operating point P_{SOLL}

difference D

first output A1

second output A2

third output A3

fourth output A4

fifth output A5

first recipe R1

second recipe R2

third recipe R3

1. A food preparation apparatus, the apparatus comprising
a rotatable chopping tool for chopping foods, wherein the chopping tool is arranged or arrangeable relative to a vessel in such a way that, after chopping by means of the chopping tool, a food falls downwards due to gravity to be collected in the vessel, and
a control unit configured to set a target parameter of a chopping process of a food by means of the chopping tool, taking into account provided information.

2. The apparatus of claim 1, wherein the food preparation apparatus further comprises a food preparation vessel, a heating element for heating a food in the food preparation vessel, a mixing tool for mixing and/or chopping a food in a bottom region of the food preparation vessel, a drive shaft for rotating the mixing tool, and an electric motor for driving the drive shaft.

3. The apparatus of claim 1, wherein the target parameter is at least one of a target cutting speed, a target cutting force, a target feed speed, and a target feed force.

4. The apparatus of claim 1, wherein the control unit is connected or connectable to a database and is configured to take a content of the database into account in addition to the provided information for setting the target parameter.

5. The apparatus of claim 1, wherein the food preparation apparatus comprises at least one sensor and the control unit is configured to set the target parameter taking into account a sensor signal of the sensor.

6. The apparatus of claim 5, wherein a sensor is provided for detecting at least one of a compressive force exerted on a part of the food preparation apparatus and a weight of a chopped food.

7. The apparatus of claim 6, wherein the control unit is configured to determine a fill level in the vessel based on the sensor signal.

8. The apparatus of claim 1, wherein that the food preparation apparatus is configured to influence a rotation of the chopping tool on the basis of the target parameter in order to control the chopping process taking into account the information,
wherein the control unit is configured to regulate the rotation of the chopping tool on the basis of the target parameter as well as a detected status information relating to an actual status.

9. The apparatus of claim 1, wherein the control unit is configured to access a characteristic curve and to take the characteristic curve into account in addition to the provided information for setting the target parameter.

10. The apparatus of claim 1, wherein the control unit is configured to output output information relating to the target parameter to a user via an output device.

11. The apparatus of claim 1, wherein the control unit is configured to receive an input of a user received via an input device as information and to set the target parameter on the basis of the received input.

12. The apparatus of claim 1, wherein the control unit is configured to output guidance information to a user via an output device, which guidance information serves for guiding the user through at least one of individual preparation and work steps of a food preparation process.

13. The apparatus of claim 1, wherein the chopping tool is rotatably arranged in a housing part, that the food preparation apparatus comprises a cover for covering the housing part with an opening for inserting food to be chopped, and that the chopping tool is arranged or arrangeable such that foods inserted through the opening are collected in the vessel after passing the chopping tool.

14. A food preparation apparatus, the apparatus comprising
a vessel,
a chopping tool mounted over the vessel, the chopping tool being configured so that food chopped by the chopping tool falls downwardly into the vessel, and
a control unit configured to direct operation of the chopping tool toward a target parameter and to set the target parameter based on provided information.

15. The apparatus of claim 14, wherein the vessel includes a food preparation vessel, a heating element mounted in the food preparation vessel, a mixing tool mounted to mix a food in a bottom region of the food preparation vessel, a drive shaft rotationally coupled to the mixing tool, and an electric motor configured to drive the drive shaft.

16. The apparatus of claim 15, wherein the target parameter is selected from a target cutting speed, a target cutting force, a target feed speed, and a target feed force.

17. The apparatus of claim 16, wherein the control unit is configured to access a characteristic curve associated with a specific food and to take the characteristic curve into account in addition to the provided information for setting the target parameter.

18. The apparatus of claim 16, further comprising a sensor, wherein the control unit is configured to set the target parameter taking into account a sensor signal from the sensor.

19. The apparatus of claim 18, wherein the sensor signal is at least one of a compressive force exerted on a part of the food preparation apparatus and a weight of a chopped food.

20. A method for chopping a food, the method comprising
providing a food preparation apparatus (1) having a rotatable chopping tool (4) for chopping foods,
arranging the chopping tool relative to a vessel in such a way that after chopping by means of the chopping tool a food falls downwards due to gravity, to be collected in the vessel,
setting a target parameter of a chopping process of a food by means of the chopping tool using a control unit taking into account provided information.
